(19) United States
(12) Patent Application Publication
(10) Pub. No.: US 2009/0010299 A1
(43) Pub. Date: Jan. 8, 2009

(54) Apparatus for Adjusting an Electrode for a Metallurgical Furnace

(76) Inventors: Karl-Heinz Kummer, Duisburg (DE); Jurgen Kunze, Xanten (DE); Horst-Dieter Borgwardt, Dorsten (DE)

Correspondence Address: FRIEDRICH KUEFFNER, 317 MADISON AVENUE, SUITE 910, NEW YORK, NY, 10017, US

(21) Appl. No.: 12/087,191

(22) PCT Filed: Dec. 7, 2006
(86) PCT No.: PCT/EP2006/011757

§ 371 Date: Jul. 21, 2008

(30) Foreign Application Priority Data
Jan. 4, 2006 (DE) 10 2006 000 737.9

(51) Int. Cl. H05B 7/10

(52) U.S. Cl. 373/69; 373/94; 373/97

(57) ABSTRACT

In an apparatus (1) for adjusting an electrode (5) of a metallurgical furnace, in particular a furnace for resistance operation having a furnace lid (15), comprising a clamping ring (3) and a holder ring (4, 14), the holder ring (4, 14) is designed to be arranged in the furnace lid (15).

The invention concerns an apparatus for adjusting an electrode for a metallurgical furnace, especially a furnace for resistance operation, with a furnace roof, which apparatus consists of a clamping ring and a mounting ring.

EP 0 733 299 B1 describes an electric arc reduction furnace with an open slag bath, especially for melting down particulate burden, with a vertically movable frame, which is mounted above the furnace, which is closed with a roof. An electrode holder and an electrode adjustment apparatus are mounted on the frame. A platform is provided, on which the frame is supported by at least three control cylinders. The platform, which is arranged above the furnace roof, is configured as a maintenance platform on which a sealing unit is provided for each electrode. The sealing unit has components for the horizontal and vertical sealing of the free surfaces between the electrodes and the electrode openings in the roof.

DE 40 10 353 C2 describes a metallurgical furnace with a self-baking electrode with a traction rod, which runs inside the electrode along its axis, extends beyond the electrode and supports it. The traction rod projects from the electrode at the end of the electrode that faces away from the molten charge, can be connected with a lockable guide mechanism for supporting and moving the electrode, and is provided with a tubular electrode-shaping device, which consists of a jacket and surrounds at least the unbaked region of the electrode. In this regard, the traction rod is preferably configured as a tube that is provided, at least over the length of the electrode, with outwardly projecting reinforcing elements. The electrode can be centered by an external horizontal centering device that acts in the baked region of the electrode.

DE 21 25 773 C3 describes a device for cooling components of open electric arc furnaces or reduction furnaces. In this device, each electrode is held by a holding and adjusting apparatus, whose position can be varied in the vertical direction and on whose support ring a support cylinder, i.e., the conductor, is mounted and tightly surrounds the electrode. The cooling device has a sealing cylinder, which surrounds these conductors, is arranged in the region of the movement of the electrode relative to a gas exhaust hood rigidly mounted above the furnace shell, and seals the electrode from the gas exhaust hood. The cooling device also supports a clamping device with current clamps for supplying electric power. The jacket of the sealing cylinder is liquid-cooled and extends below the gas exhaust hood towards the furnace shell and surrounds the conductors. Removable segmental cooling shields, which are connected with one another, reach as far as the clamping device, and have coolant flowing through them, are mounted on the end of the sealing cylinder that faces the furnace shell. The coolant circulation of the cooling shields is connected to the coolant circulation of the sealing cylinder.

DE 33 42 900 A1 discloses an electrode holder system for electrothermal melting furnaces, which contain current clamps for conducting electric current to an electrode and hydraulic cylinders for moving the electrode up and down. The hydraulic cylinders are connected with the electrode by an electrode holder and clamping means. At least two guide rails are arranged parallel to the electrode. The upper ends of the guide rails are suspended on a suspension frame, and the lower ends of the guide rails have stops that represent the lower limit of movement of the current-conducting clamps.

EP 1 068 496 B1 describes a method for weighing an electrode submerged in the charge of an electric melting furnace. The electrode is moved at least once in the vertical direction and is then lifted, and the weight of the electrode is recorded shortly after it has been lifted in order to eliminate the effect of the dynamic and static friction between the electrode and the furnace charge.

DE 1 440 991 describes a method for raising and lowering electrodes relative to the electrode holder in electric melting furnaces, in which the electrode is equipped with a clamping ring, which is mounted above the electrode holder and is connected with double-acting hydraulic/pneumatic rams. The clamping ring is pulled down and pushed up by means of combined pneumatic and hydraulic pressure in a closed system.

WO 2004/110104 A1 describes a direct-current arc furnace with at least one electrode, which is held inside the furnace and can be readjusted to compensate electrode burn-off, and with a counter electrode in the furnace, for example, a bottom electrode. In this connection, the entire electrode strand with an electrode holder and an adjustment apparatus is mounted on a topside platform or frame above the furnace.

In the previously known embodiments, the electrodes are held and adjusted by an adjusting apparatus with two clamping rings. The clamping rings are equipped with clamping springs to hold the electrode and with hydraulic cylinders for opening the clamping springs. A mounting ring is arranged at the lower end of the electrode. Its integrated contact clamps serve exclusively for supplying current to the electrodes. An embodiment of this type results in a high level of technical complexity and a complicated design of the adjusting apparatus. This results in high manufacturing costs.

Therefore, the objective of the invention is to design an adjusting apparatus in such a way that it is simplified and avoids the disadvantages described above. In addition, the improved design of the adjusting apparatus is intended to lower the manufacturing costs.

In accordance with the invention, in an apparatus for adjusting an electrode according to the introductory clause of claim 1, this objective is achieved by designing the mounting ring to be installed in the furnace roof.

Further embodiments of the adjusting apparatus are specified in the related dependent claims.

The crucial advantage of the adjusting apparatus of the invention is that the function of the two clamping rings of the adjusting apparatus is transferred to the mounting ring with its contact clamps.

Furthermore, as a result of the design of the adjusting apparatus of the invention, the inclusion of an electric arc reduction furnace with compact strands in plans for existing furnace buildings is facilitated or is made possible for the first time.

The indicated improvements reduce the number of parts used, reduce the overall height of the apparatus for adjusting an electrode, simplify the hydraulic system, and therefore reduce the costs of the whole apparatus.

Specific embodiments of the invention are described in detail below with reference to the highly schematic drawings.

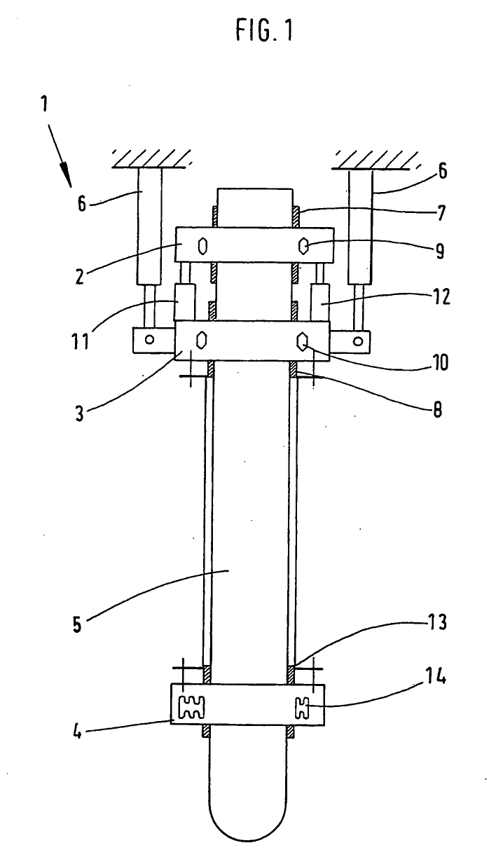

FIG. 1 shows a side view of a previously known adjusting apparatus.

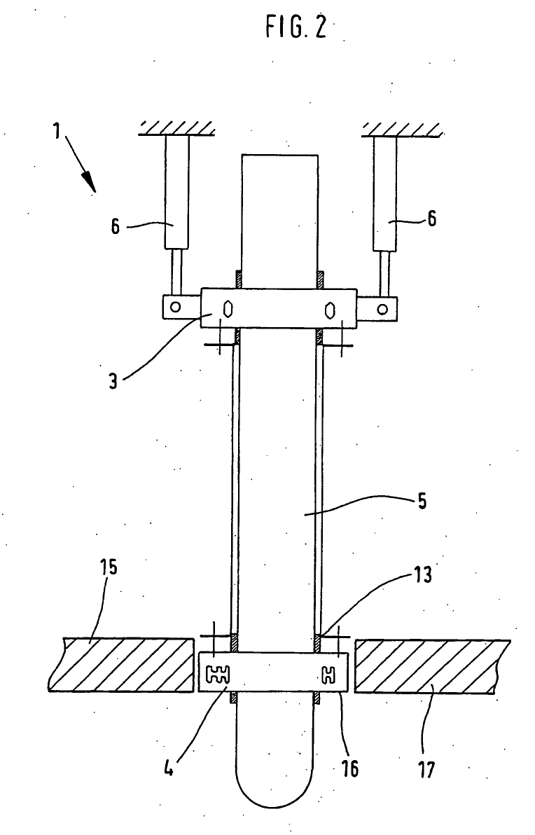

FIG. 2 shows a side view of an adjusting apparatus of the invention.

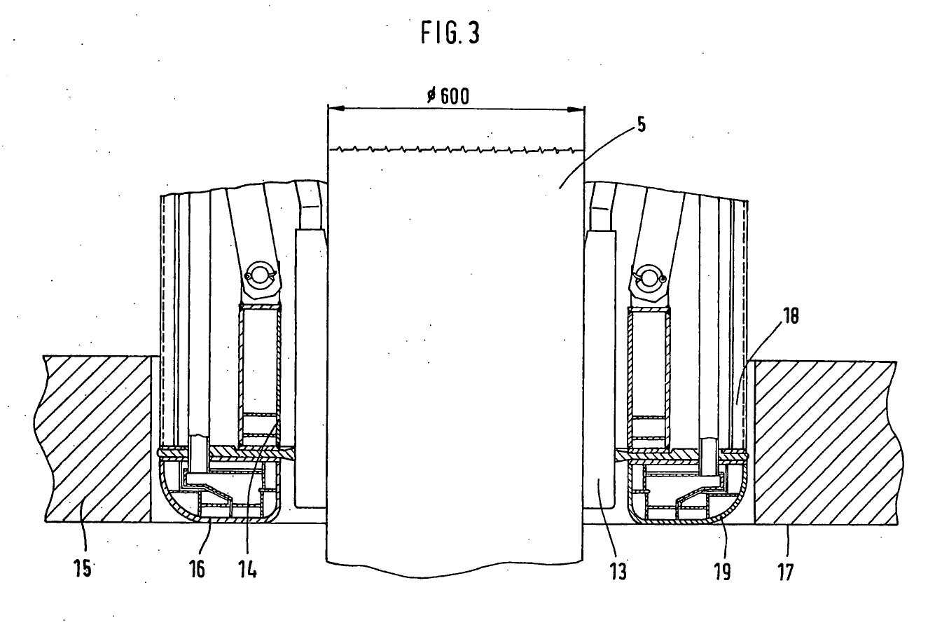

FIG. 3 shows a cutaway side view of a mounting ring as an individual member.

FIG. 1 shows a prior-art adjusting apparatus 1, which consists of an upper clamping ring 2, a lower clamping ring 3, and a mounting ring 4, which surround the electrode 5. The lower clamping ring 3 is vertically controlled by control cylinders 6. At least one pressure clamp 7, 8 is integrated in each clamping ring 2, 3. Each pressure clamp 7, 8 is pressed against the electrode 5 by a spring 9, 10 to hold the electrode 5. The electrode 1 can be lowered into a furnace (not shown) by lifting cylinders 11, 12, which are vertically positioned between the upper clamping ring 2 and the lower clamping ring 3. The electrode is lowered by utilizing the stroke of the lifting cylinders 11, 12.

The mounting ring 4, which surrounds the lower end of the electrode 5, is designed with at least one contact clamp 13, which is pressed against the electrode 5 by a hydraulic cylinder 14 to allow constant current conduction.

FIG. 2 shows an adjusting apparatus of the invention. Parts that are the same as parts shown in FIG. 1 are identified by the same reference numbers.

In accordance with the invention, the adjusting apparatus 1 has a clamping ring 3, which can be moved vertically by control cylinders 6. The mounting ring 4 is mounted in a furnace roof 15. To protect it, the lower edge 16 of the mounting ring 4 is formed flush with the lower edge 17 of the furnace roof 15.

To adjust or lower the electrode 5, the control cylinders 6 are extended. When their full stroke has been reached, the electrode 5 is held by the mounting ring 4, and the clamping ring 3 is released and moved vertically upward by the control cylinders 6. When the control cylinders have returned to their original point, the electrode 5 is held by the clamping ring 3 again, and the clamping on the mounting ring 4 is released. During this entire time, the electrode 5 is supplied with current through the contact clamps 13. Further adjustment or lowering is again carried out by the control cylinders 6.

FIG. 3 shows a cutaway side view of the mounting ring 4 as an individual member. The contact clamp 13, which is in contact with the electrode 5, is surrounded by the mounting ring 14. This unit is surrounded by a sealing cylinder 18 and by a guard ring 19 that is formed on the sealing cylinder 18. The lower edge 16 of the mounting ring and the lower edge 17 of the furnace roof 15 are formed flush with each other.

### LIST OF REFERENCE NUMBERS

1 adjusting apparatus
2 upper clamping ring
3 lower clamping ring
4 mounting ring
5 electrode
6 control cylinder
7 pressure clamp
8 pressure clamp
9 spring
10 spring
11 lifting cylinder
12 lifting cylinder
13 contact clamp
14 mounting ring
15 furnace roof
16 lower edge of the mounting ring
17 lower edge of the furnace roof
18 sealing cylinder
19 guard ring

1. An apparatus (1) for adjusting an electrode (5) for a metallurgical furnace, especially a furnace for resistance operation, with a furnace roof (15), which apparatus consists of a clamping ring (3) and a mounting ring (4, 14), wherein the mounting ring (4, 14) is designed to be installed in the furnace roof (15).

2. An apparatus (1) in accordance with claim 1, wherein the lower edge (16) of the mounting ring (4, 14) is formed flush with the lower edge (17) of the furnace roof (15).

3. An apparatus (1) in accordance with claim 1, wherein the electrode (5) is made of graphite.

4. An apparatus (1) in accordance with claim 1, wherein the electrode (5) is made of carbon.

5. An apparatus (1) in accordance with claim 1, wherein the electrode (5) is made of Soderberg paste.

6. An apparatus (1) in accordance with claim 1, wherein the electrode (5) is formed as a solid electrode.

7. An apparatus (1) in accordance with claim 1, wherein the electrode (5) is formed as a hollow electrode.

8. An apparatus (1) in accordance with claim 1, wherein the number of electrodes (5) is 1, 2, 3, 4, 5, or 6.
